(19) United States
(12) Patent Application Publication
(10) Pub. No.: US 2026/0127399 A1
(43) Pub. Date: May 7, 2026

(54) BARCODE RECOGNITION METHOD AND BARCODE READER CAMERA

(71) Applicant: HANWHA VISION CO., LTD., Seongnam-si (KR)

(72) Inventors: Soo Hyun JUNG, Seongnam-si (KR); Chang Hyun KIM, Seongnam-si (KR)

(73) Assignee: HANWHA VISION CO., LTD., Seongnam-si (KR)

(21) Appl. No.: 19/379,234

(22) Filed: Nov. 4, 2025

(30) Foreign Application Priority Data
Nov. 5, 2024 (KR) 10-2024-0155668

(51) Int. Cl. G06K 7/14; G06T 5/73; G06T 7/246; G06T 7/277; G06T 7/80

(52) U.S. Cl. CPC G06K 7/146; G06T 5/73; G06T 7/251; G06T 7/277; G06T 7/80; G06T 2207/20024; G06T 2207/20084; G06T 2207/20092; G06T 2207/20201

(57) ABSTRACT

A method of recognizing a barcode by using a barcode reader (BCR) camera installed in a conveyor environment includes: obtaining, by using a BCR camera, a barcode image of a barcode on an object on a conveyor; obtaining a field of view of the BCR camera based on a conveyor environmental condition and a BCR camera setting condition; obtaining a moving distance of the object on the conveyor by using the field of view of the BCR camera, the conveyor environmental condition, and the BCR camera setting condition; generating a blur kernel of the barcode based on a moving direction of the object and the moving distance of the object; and deblurring the barcode image by using a pre-trained deblurring algorithm based on the blur kernel.

### CROSS-REFERENCE TO RELATED APPLICATION

This application is based on and claims priority under 35 U.S.C. § 119 to Korean Patent Application No. 10-2024-0155668, filed on Nov. 5, 2024, in the Korean Intellectual Property Office, the disclosure of which is incorporated herein in its entirety by reference.

### BACKGROUND

### 1. Field

Embodiments of the disclosure relate to a barcode recognition method and a barcode reader (BCR) camera.

### 2. Description of the Related Art

Since barcode reader (BCR) cameras are capable of accurately recognizing a barcode even in high-speed conveyor environments, they may be utilized to automate logistics and enhance operational reliability. However, for accurate barcode recognition, high-resolution barcode images with minimal blurring are required. In general, pixels per module (PPM), which is required for barcode recognition, is an important indicator indicating the resolution of a barcode reader and refers to the number of pixels per barcode module. However, when blurring occurs in the barcode, barcode recognition becomes more difficult because it is difficult to distinguish the barcode modules, which are the widths of the smallest units that constitute the barcode.

According to the related art, when it is assumed that a blur kernel existing in a barcode image is a camera blur that occurs only in a camera optical system or when motion blur is assumed, deconvolution is optimized through the difference in features between a clear barcode and a deblurred barcode. However, these techniques require a long time to estimate a blur kernel because an algorithm of repeatedly finding the blur kernel has to be performed so as to find an optimal blur kernel. In addition, a system is limited to a mobile terminal device and a fixed camera is not assumed. Therefore, blur kernel estimation is difficult because the speed of movement is not constant and the direction of movement has to account not only for the movement of the object but also for the movement of the camera.

### SUMMARY

Provided are a barcode recognition method and a barcode reader (BCR) camera configured to implement the barcode recognition method. However, this is only an example and the scope of the disclosure is not limited thereto.

Various aspects of the disclosure will be set forth in part in the description which follows and, in part, will be apparent from the description, or may be learned by practice of the presented embodiments of the disclosure.

According to an aspect of the disclosure, a method of recognizing a barcode by using a BCR camera installed in a conveyor environment may include: obtaining, by using a BCR camera, a barcode image of a barcode on an object on a conveyor; obtaining a field of view of the BCR camera based on a conveyor environmental condition and a BCR camera setting condition; obtaining a moving distance of the object on the conveyor by using the field of view of the BCR camera, the conveyor environmental condition, and the BCR camera setting condition; generating a blur kernel of the barcode based on a moving direction of the object and the moving distance of the object; and deblurring the barcode image by using a pre-trained deblurring algorithm based on the blur kernel.

The obtaining the field of view of the BCR camera may include: obtaining a horizontal viewing angle and a vertical viewing angle based on an installation height of the BCR camera with respect to the conveyor, a sensor size of the BCR camera, and a focal length of the BCR camera; and obtaining a horizontal field of view area and a vertical field of view area based on the horizontal viewing angle and the vertical viewing angle, respectively.

The obtaining the moving distance may include: obtaining an actual moving distance of the object according to a single frame based on a speed of the conveyor and a shutter speed of the BCR camera; and converting the actual moving distance into a moving distance according to a single pixel.

The generating the blur kernel may include: obtaining a motion vector based on the moving distance according to the single pixel and the moving direction of the object; and generating the blur kernel based on the motion vector.

The deblurring may include deblurring the barcode image based on the blur kernel and the barcode image by using a Wiener filter algorithm.

According to an aspect of the disclosure, a BCR camera installed in a conveyor environment may include; an image sensor configured to obtain a barcode image of a barcode on an object moving in a moving direction at a constant speed on a conveyor at a fixed distance from the BCR camera; and a processor configured to obtain a field of view of the BCR camera based on a conveyor environmental condition and a BCR camera setting condition, obtain a moving distance of the object on the conveyor by using the field of view of the BCR camera, the conveyor environmental condition, and the BCR camera setting condition, generate a blur kernel based on the moving direction of the object and the moving distance of the object, and deblur the barcode image by using a pre-trained deblurring algorithm based on the blur kernel.

The processor may be further configured to obtain a horizontal viewing angle and a vertical viewing angle based on an installation height of the BCR camera with respect to the conveyor, a size of the image sensor of the BCR camera, and a focal length of the BCR camera, and obtain a horizontal field of view area and a vertical field of view area based on the horizontal viewing angle and the vertical viewing angle, respectively.

The processor may be further configured to obtain an actual moving distance of the object according to a single frame based on a speed of the conveyor and a shutter speed of the BCR camera, and convert the actual moving distance into a moving distance according to a single pixel.

The processor may be further configured to obtain a motion vector based on the moving distance according to the single pixel and the moving direction of the cargo, and generate a blur kernel based on the motion vector.

The processor may be further configured to deblur the barcode image based on the blur kernel and the barcode image by using a Wiener filter algorithm.

According to an aspect of the disclosure, a method of recognizing a barcode by using a BCR camera installed in a conveyor environment may include: obtaining, by using the BCR camera, a barcode image of a barcode on an object moving in a moving direction on a conveyor at a fixed distance from the BCR camera; receiving a conveyor environmental condition and a BCR camera setting condition from a user; obtaining a field of view of the BCR camera based on the conveyor environmental condition and the BCR camera setting condition, and obtaining a moving distance of the object on the conveyor by using the field of view of the BCR camera, the conveyor environmental condition, and the BCR camera setting condition; generating a blur kernel based on the moving direction and the moving distance of the object; and deblurring the barcode image by using a pre-trained deblurring algorithm based on the blur kernel.

The generating the blur kernel may include recalculating a moving speed of the cargo on the conveyor at preset time intervals or based on a user input, recalculating the moving distance, and regenerating the blur kernel based on the recalculated moving distance.

Other aspects, features, and advantages of the disclosure will become apparent from the following detailed description, the claims, and the drawings for carrying out the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an operation of a barcode reader (BCR) camera that recognizes a barcode, according to one or more embodiments;

FIG. 2 illustrates a configuration and an operation of a BCR camera according to one or more embodiments;

FIG. 3 is a flowchart of a barcode recognition method according to one or more embodiments;

FIG. 4 is a flowchart of a barcode recognition method according to another embodiment; and

FIGS. 5 and 6 illustrate a barcode recognition method according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the present description allows for various changes and numerous embodiments, certain embodiments will be illustrated in the drawings and described in detail in the written description. Effects and features of the disclosure, and methods of achieving them will be clarified with reference to embodiments described below in detail with reference to the drawings. However, the disclosure is not limited to the following embodiments and may be embodied in various forms.

Hereinafter, embodiments will be described in detail with reference to the accompanying drawings. When describing embodiments with reference to the accompanying drawings, the same or corresponding elements are denoted by the same reference numerals, and redundant descriptions thereof are omitted.

In the following embodiments, the terms “first,” “second,” etc. are not used in a restrictive sense and are used to distinguish one element from another. In addition, the singular forms as used herein are intended to include the plural forms as well unless the context clearly indicates otherwise. It will be further understood that the terms “include” and/or “comprise” used herein specify the presence of stated features or elements, but do not preclude the presence or addition of one or more other features or elements.

Also, sizes of elements in the drawings may be exaggerated or reduced for convenience of explanation. For example, because sizes and thicknesses of elements in the drawings are arbitrarily illustrated for convenience of explanation, the disclosure is not necessarily limited thereto.

It will be further understood that, when a region, element, unit, block, or module is referred to as being “on” another region, element, unit, block, or module, it may be directly on the other region, element, unit, block, or module, but also intervening regions, elements, units, blocks, or modules may be present therebetween. It will be further understood that, when regions, elements, units, blocks, or modules are referred to as being connected to each other, they may be directly connected to each other or indirectly connected to each other with intervening regions, elements, units, blocks, or modules therebetween.

Hereinafter, various embodiments will be described in detail with reference to the accompanying drawings so that those of ordinary skill in the art may easily carry out the disclosure.

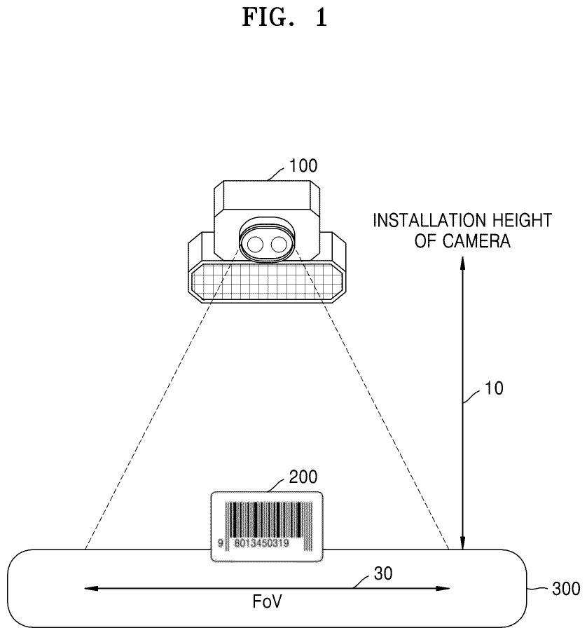

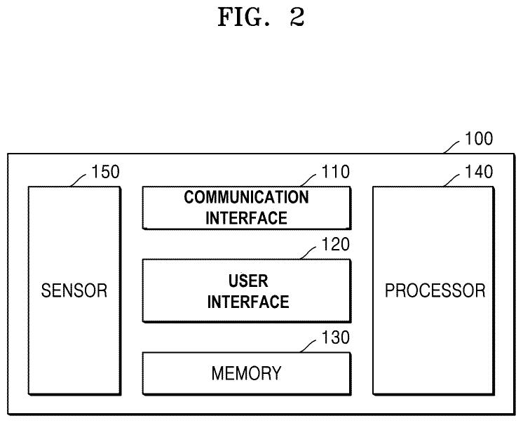

FIG. 1 illustrates an operation of a barcode reader (BCR) camera that recognizes a barcode, according to one or more embodiments. FIG. 2 illustrates a configuration and an operation of the BCR camera shown in FIG. 1 according to one or more embodiments.

Referring to FIGS. 1 and 2, a barcode recognition system according to one or more embodiments may include a BCR camera 100. However, the disclosure is not limited thereto, and the barcode recognition system according to one or more embodiments may further include other components or some components may be omitted. Some components of the barcode recognition system according to one or more embodiments may be separated into a plurality of devices, or a plurality of components may be combined into a single device. For example, as illustrated in FIG. 1, the barcode recognition system according to one or more embodiments may include the BCR camera 100 installed above a conveyor 300 on which a cargo with a barcode 200 attached thereto moves.

In addition, although FIG. 1 illustrates one BCR camera 100, the barcode recognition system according to one or more embodiments may include one BCR camera or two or more BCR cameras.

The BCR camera 100 may include a camera device that recognizes a barcode. For example, as illustrated in FIGS. 1 and 2, the BCR camera 100 according to one or more embodiments may include a sensor 150. For example, the BCR camera 100 may include a mono sensor and a color sensor. The mono sensor and the color sensor may be referred to as image sensors, for example, complementary metal-oxide-semiconductor (CMOS) image sensors. The mono sensor may be configured to include a mono sensor for mono image capturing, and the color sensor may be configured to include a color sensor for color image capturing. For example, the BCR camera 100 according to one or more embodiments may include a mono sensor and a color sensor in one housing. The mono sensor and the color sensor according to one or more embodiments may be simultaneously triggered by a single signal in a single system on chip (SoC). For example, the mono sensor and the color sensor may be triggered simultaneously so that the image capturing time points of the mono sensor and the color sensor may be synchronized with each other.

For example, as illustrated in FIG. 1, the BCR camera 100 according to one or more embodiments may be installed to have a preset height 10 with respect to the conveyor 300. In addition, the BCR camera 100 according to one or more embodiments may have a field of view 30 (e.g., a viewing angle).

Referring to FIG. 2, the BCR camera 100 according to one or more embodiments may include a memory 130, a processor 140, a communication interface 110, and a user interface 120. In addition, the BCR camera 100 according to one or more embodiments may include the sensor 150. The sensor 150 may obtain a barcode image of a barcode attached to a cargo on a conveyor. For example, the sensor 150 may include a color sensor and a mono sensor. However, the disclosure is not limited thereto, and the BCR camera 100 according to one or more embodiments may further include other components, or some components may be omitted.

The communication interface 110 may provide a function of communicating with an external device via a network. For example, a request generated by the processor 140 of the BCR camera 100 according to program code stored in a recording device such as the memory 130 may be transmitted to the external device via the network under the control of the communication interface 110. Conversely, control signals, instructions, contents, files, etc. provided from the external device may be received by the BCR camera 100 through the communication interface 110 via the network. For example, the control signals or instructions received from the external device through the communication interface 110 may be transmitted to the processor 140 or the memory 130. The communication interface 110 may be or include at least one of a digital modem, a radio frequency (RF) modem, an antenna circuit, a WiFi chip, and related software and/or firmware.

Communication schemes are not limited and may include not only communication schemes using a communication network that the network may include (e.g., a mobile communication network, wired Internet, wireless Internet, a broadcasting network, etc.), but also short-range wireless communication between devices. For example, the network may include any one or more of a personal area network (PAN), a local area network (LAN), a campus area network (CAN), a metropolitan area network (MAN), a wide area network (WAN), a broadband network (BBN), and the Internet. In addition, the network may include any one or more of network topologies including a bus network, a star network, a ring network, a mesh network, a star-bus network, and a tree or hierarchical network, but the disclosure is not limited thereto.

In addition, the communication interface 110 may communicate with the external server via the network. The communication scheme is not limited, and the network may be a short-range wireless network. For example, the network may be a Bluetooth, Bluetooth Low Energy (BLE), or Wireless Fidelity (Wi-Fi) communication network.

In addition, the BCR camera 100 according to one or more embodiments may include the user interface 120. The user interface 120 may be a means for interfacing with an input/output device. For example, the input device may include devices such as a keyboard or a mouse, and the output device may include devices such as a display for displaying a communication session of an application. As another example, the user interface 120 may be a means for interfacing with a device (e.g., a touchscreen) into which input and output functions are integrated. As a more specific example, the processor 140 of the BCR camera 100 may display, on a display through the user interface 120, a service screen or content configured by using data provided by the external device when processing instructions of a computer program loaded into the memory 130.

The memory 130 is a computer-readable recording medium and may include a permanent mass storage device such as random-access memory (RAM), read-only memory (ROM), or disk drive. In addition, program code for controlling the camera may be temporarily or permanently stored in the memory 130.

The processor 140 may control the overall operation of the BCR camera 100. For example, the processor 140 may be implemented by optionally including a processor, an application-specific integrated circuit (ASIC), another chipset, a logic circuit, a register, a communication modem, and/or a data processing device, which are known in the art, so as to perform the above-described operations. For example, the processor 140 may perform basic arithmetic, logic, and input/output operations and execute, for example, the program code stored in the memory 130. The processor 140 may store data in the memory 130, or may load data stored in the memory 130.

The processor 140 according to one or more embodiments may calculate the field of view 30 of the BCR camera 100 based on a conveyor environmental condition and a BCR camera setting condition. In addition, the processor 140 may calculate a moving distance of the cargo on the conveyor 300 by using the field of view 30 of the BCR camera 100, the conveyor environmental condition, and the BCR camera setting condition. In addition, the processor 140 may generate a blur kernel based on a moving direction and a moving distance of the cargo. Furthermore, the processor 140 may deblur the barcode image by using a pre-trained deblurring algorithm based on the blur kernel.

The processor 140 and the components of the processor 140 may be implemented to execute instructions according to code of at least one program and code of an operating system included in the memory 130. The components of the processor 140 may be representations of different functions of the processor 140 performed by the processor 140 according to the instructions provided by the program code stored in the memory 130.

The processor 140 may train an artificial intelligence (AI) algorithm by using the program stored in the memory 130. In particular, the processor 140 may train an AI algorithm for analyzing image-related data. The AI algorithm for analyzing image-related data may be designed to simulate a human brain structure on a computer and may include a plurality of network nodes with weights, which simulate neurons of a human neural network. The plurality of network nodes may exchange data according to their connection relationships so as to simulate the synaptic activity of neurons exchanging signals through synapses. The AI algorithm may include a deep learning model. In the deep learning model, a plurality of network nodes may be located in different layers and exchange data based on convolutional connection relationships. For example, examples of the AI algorithm may include deep neural networks (DNNs), convolutional deep neural networks (CNNs), recurrent Boltzmann machine (RNN), restricted Boltzmann machine (RBM), deep belief networks (DBNs), and deep Q-networks.

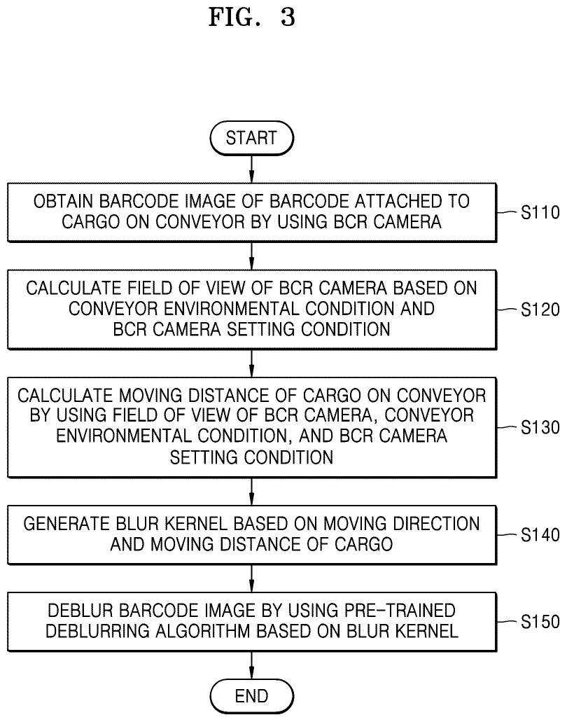

FIG. 3 is a flowchart of a barcode recognition method according to one or more embodiments. For example, the barcode recognition method according to one or more embodiments may be performed by the processor 140 illustrated in FIG. 2.

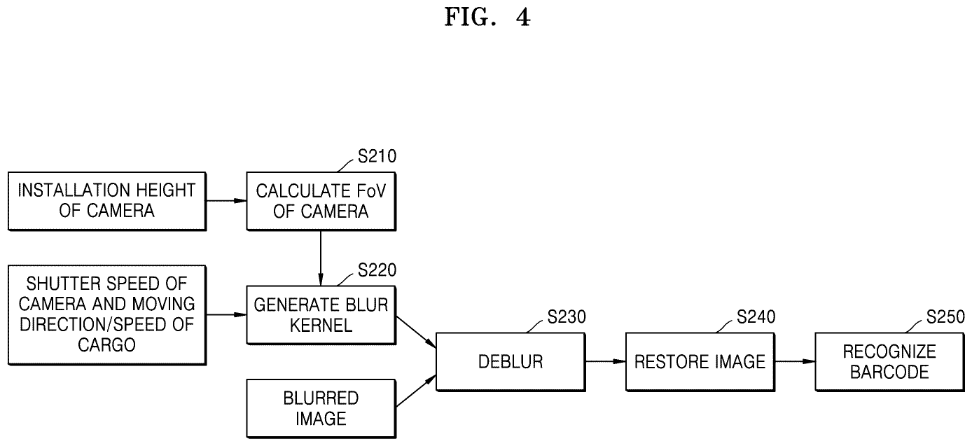

Referring to FIG. 4, in the barcode recognition method according to one or more embodiments, in operation S110, the processor 140 may obtain a barcode image of the barcode 200 attached to a cargo on the conveyor 300 by using the BCR camera 100.

In operation S120, the processor 140 may calculate the field of view 30 of the BCR camera 100 based on a conveyor environmental condition and a BCR camera setting condition. For example, the processor 140 may calculate a horizontal viewing angle and a vertical viewing angle based on the installation height 10 of the BCR camera 100 with respect to the conveyor, a sensor size of the BCR camera 100, and a focal length of the BCR camera 100. The sensor size may refer to a size of a pixel array of the image sensor of the BCR camera 100. In addition, the processor 140 may calculate a horizontal field of view area and a vertical field of view area based on the horizontal viewing angle and the vertical viewing angle, respectively.

In operation S130, the processor 140 may calculate a moving distance of the cargo on the conveyor 300 by using the field of view of the BCR camera 100, the conveyor environmental condition, and the BCR camera setting condition. In addition, the processor 140 may calculate an actual moving distance of the cargo according to a single frame based on speed of the conveyor and shutter speed of the BCR camera 100. In addition, the processor 140 may convert the actual moving distance into a moving distance according to a single pixel.

In operation S140, the processor 140 may generate a blur kernel based on the moving distance and a moving direction of the cargo. In addition, the processor 140 may calculate a motion vector based on the moving distance according to a single pixel and the moving direction of the cargo. In addition, the processor 140 may generate the blur kernel based on the motion vector.

In operation S150, the processor 140 may deblur the barcode image by using a pre-trained deblurring algorithm based on the blur kernel. Furthermore, the processor 140 may deblur the barcode image based on the blur kernel and the barcode image by using a Wiener filter algorithm.

FIG. 4 is a flowchart of a barcode recognition method according to one or more other embodiments.

Referring to FIG. 4, the disclosure proposes a method of increasing barcode recognition performance in a high-speed conveyor environment of a fixed barcode camera by calculating a blur kernel based on a conveyor speed, camera installation height, and shutter speed information and applying a deblurring algorithm based on the calculated blur kernel to remove a blurring phenomenon of an image and thus increase sharpness.

For example, as illustrated in FIG. 4, in the barcode recognition method according to one or more embodiments, in operation S210, the processor 140 may calculate the field of view (FoV) 30 of the BCR camera 100 by using Equation 1 below through the installation height 10 of the BCR camera 100, a size of a camera sensor, and a focal length of a lens of the BCR camera 100. In addition, the processor 140 may calculate a horizontal field of view (HFoV) and a vertical field of view (VFoV) (e.g., HFoV area and VFoV area) of the BCR camera 100 by using Equation 2 below, based on the FoV of the BCR camera 100 and a distance between the BCR camera 100 and the conveyor 300.

$$field of view = 2 \cdot arctan ( \frac{sensor size}{2 \cdot focal length} ) \qquad [ Equation 1 ]$$

$$horizontal field of view area = 2 \cdot working distance \cdot tan ( \frac{horizontal field of view}{2} ) \qquad [ Equation 2 ]$$

$$vertical field of view area = 2 \cdot working distance \cdot tan ( \frac{horizontal field of view}{2} )$$

For example, when it is assumed that the distance between the BCR camera 100 and the conveyor 300 is 1.70 m, the focal length is 25 mm, and the sensor size is 16 mm in the horizontal axis and 10 mm in the vertical axis, the horizontal viewing angle and the vertical viewing angle are respectively calculated to be 35.48° and 22.6° through Equation 1 above, and the HFoV area and the VFoV area are respectively calculated to be 1.08 m and 0.67 m through Equation 2 above.

In addition, the processor 140 may calculate the moving distance of the cargo by using the HFoV, the VFoV, the speed of the conveyor 300 (e.g., moving speed of a conveyor belt), and the shutter speed. For example, the processor 140 may calculate an actual moving distance per frame based on the conveyor speed and the shutter speed by using Equation 3 below. In addition, the processor 140 may calculate a moving distance per pixel by using Equation 4, which multiplies a ratio of a resolution of the image and the HFoV area obtained from Equation 2 by the actual moving distance obtained from Equation 3.

$$object speed ( m / s ) \cdot shutter speed ( s ) = moving distance ( m ) \qquad [ Equation 3 ]$$

$$\frac{image resolution ( pixel )}{horizontal field of view area ( m )} \cdot moving distance ( m ) = moving distance ( pixel ) \qquad [ Equation 4 ]$$

For example, when it is assumed the speed of the conveyor 300 is m/s and an exposure time is 1/500 second, the actual moving distance per frame is calculated to be 0.004 m/s by using Equation 3. When converted to pixel units by using Equation 4, an object (e.g., cargo) may move 8.64 pixels per frame at a resolution of 4096×2160. At this time, it is assumed that the conveyor 300 moves along the vertical axis and the conveyor belt and the BCR camera 100 are installed perpendicular to each other.

In operation S220, the moving distance of the object per frame is equal to an intensity of a motion blur, and thus, when it is assumed that the movement of the object occurs in the vertical axis direction, a direction of the motion blur may be set. Accordingly, both a size and a direction of a blur kernel may be known, and the motion vector may be calculated. For example, the intensity of the motion blur based on the motion vector is calculated by dividing it by a length of the motion vector so that a sum of the entire blur kernel is 1, and the blur kernel is generated based on the axis on an assumption that the direction of the motion blur is a single axis and the motion blur occurs along the single axis.

The processor 140 may generate the blur kernel on an assumption that the motion blur occurs along the vertical axis by using Equation 5 below. This is only an embodiment, and the movement of the object is not limited to the vertical axis direction. For example, this may also be applied to a diagonal or horizontal movement.

$$PSF = {\frac{1}{blur length} [ 111 … 1 ]}^{T} \qquad [ Equation 5 ]$$

In operation S230, the processor 140 may apply deblurring by using the blur kernel. For example, the processor 140 may use a Wiener filter algorithm as an algorithm for removing the motion blur. For example, the Wiener filter algorithm may operate in a way that minimizes mean squared error between an estimated image and an actual image.

In operations S240 and S250, the processor 140 may recognize the barcode 200 based on a restored image in which blurring of the barcode 200 has been removed.

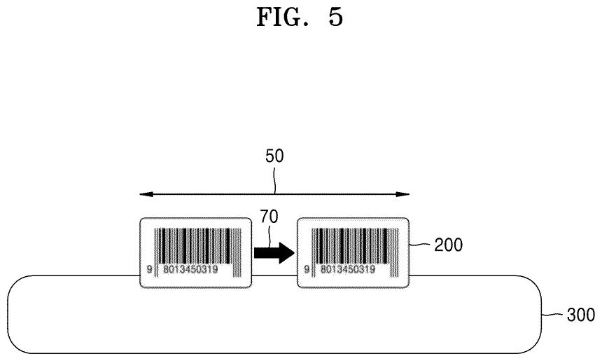

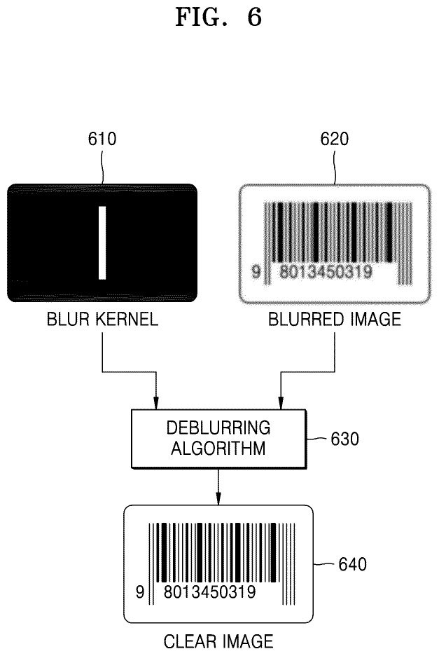

FIGS. 5 and 6 illustrate a barcode recognition method according to one or more embodiments.

Blur kernel prediction is important to improve the performance of the deblurring algorithm. Blur kernel prediction methods are largely classified into estimation methods and calculation methods. The estimation methods estimate a blur kernel by using statistical features of an image under an assumption that no external information about the blur kernel is known. Since estimating the blur kernel by using only the image is not easy, the performance is poor and the speed is low. On the other hand, the calculation methods are superior in performance and speed because a more accurate blur kernel may be obtained by performing calculation by using an equation on an assumption that camera parameters and information about movement of an object are known.

Since BCR cameras are mostly used in fixed environments, blur prediction is relatively simple when using the calculation methods. To calculate the blur kernel, information about intensity and a direction of the blur kernel are required.

For example, as illustrated in FIG. 5, the processor 140 may predict kernel intensity by calculating a moving distance 50 of a barcode 200 through a speed of the conveyor 300 and a shutter speed, calculating an actual distance per pixel by using camera installation distance information, and then combining the moving distance 50 and the actual distance per pixel. In addition, the processor 140 may predict a blur kernel direction through a moving direction 70 of the conveyor 300 and a direction in which the BCR camera 100 views the object including the barcode 200.

For example, as illustrated in FIG. 6, when a blur kernel 610 is predicted, the processor 140 may apply a deblurring algorithm 630 to a blurred image 620. For example, a Wiener filter algorithm may be applied as the deblurring algorithm 630. Thereafter, the processor 140 may obtain a clear image 640 by using the deblurring algorithm 630.

Conveyor environments require barcodes to pass by at high speeds, which may cause blurring in video images. To eliminate a blur of a barcode, the barcode passes by at a low speed, or in an environment with sufficient lighting (e.g., illuminance) even at a high speed, the blur is mitigated, but in extreme environments (e.g., low luminance/long exposure time/high-speed conveyor belt), a blur is inevitable. To compensate for this, a recognition rate may be increased by analyzing the barcode through the deblurring algorithm.

The BCR camera according to one or more embodiments may be fixedly installed in a conveyor environment. For example, the BCR camera may be installed at a fixed distance from the conveyor.

The BCR camera according to one or more embodiments may obtain a barcode image of a barcode attached to a cargo moving only in one direction at a constant speed on a conveyor at a fixed distance from the BCR camera. For example, the cargo on the conveyor may move only in one direction on the conveyor belt that moves in the same direction. For example, the moving direction of the cargo may be preset, or the moving direction of the cargo may be calculated based on the movement of the cargo on the images at preset time intervals. For example, the cargo on the conveyor may move at a constant speed on the conveyor belt that moves at a constant speed. In one or more other embodiments, the moving speed of the cargo may be changed. For example, the BCR camera according to one or more embodiments may recalculate the moving speed of the cargo on the conveyor at preset time intervals or based on a user input, recalculate the moving distance of the cargo, and regenerate the blur kernel based on the recalculated moving distance.

The BCR camera according to one or more embodiments may receive a conveyor environmental condition and a BCR camera setting condition from a user. For example, the BCR camera may obtain a conveyor environmental condition and a BCR camera setting condition based on a user input that is input from a user interface. For example, the BCR camera may receive, through a user interface screen, inputs such as the installation height of the BCR camera with respect to the conveyor, the sensor size of the BCR camera, the focal length of the BCR camera, the speed of the conveyor, the shutter speed of the BCR camera, and the moving direction of the cargo. For example, the BCR camera may calculate the field of view of the camera and the moving distance of the cargo based on the conveyor environmental condition and the BCR camera setting condition input by the user, and generate the blur kernel based on the moving direction of the cargo and the moving distance of the cargo. The disclosure proposes the blur removal technique specialized for the high-speed conveyor environment of the fixed barcode camera. According to the disclosure, since the accurate blur kernel is calculated, blurring of the barcode of the cargo caused by high-speed movement of the conveyor may be removed.

According to the disclosure, even in situations where the illumination is low and the barcode on the cargo moves at a high speed, a clear image in which the blur is removed may be obtained without reducing the exposure time, thereby enabling accurate barcode recognition.

The devices and/or systems described above may be implemented as hardware components, software components, and/or a combination of hardware components and software components. The devices and components described in the embodiments may be implemented by using one or more general-purpose computers or special-purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing instructions and responding. A processing device may execute an operating system (OS) and one or more software applications running on the OS. In addition, the processing device may access, store, manipulate, process, and generate data in response to the execution of the software. For ease of understanding, the processing device is sometimes described as being used alone, but it may be understood by those of ordinary skill in the art that the processing device includes a plurality of processing elements and/or a plurality of types of processing elements. For example, the processing device may include a plurality of processors or one processor and one controller. In addition, other processing configurations, such as parallel processors, are also possible.

The software may include a computer program, code, instructions, or a combination of one or more thereof, and may configure a processor to operate as desired or may instruct the processor independently or collectively. The software and/or data may be permanently or temporarily embodied in any type of machine, component, physical device, virtual device, computer storage medium or device, or a signal wave to be transmitted, so as to be interpreted by the processing device or to provide instructions or data to the processing device. The software may be distributed in network-connected computer systems and stored or executed in a distributed manner. The software and data may be stored on one or more computer-readable recording media.

The method according to one or more embodiments may be implemented in the form of program instructions that are executable through a variety of computer means and may be recorded on a computer-readable medium. The computer-readable storage medium may include program instructions, data files, data structures, etc. alone or in combination. The program instructions recorded on the medium may be specially designed and configured for the embodiment or may be known and available to those of ordinary skill in the art of computer software. Examples of the computer-readable recording medium may include magnetic media, such as hard disk, floppy disk, and magnetic tape, optical media, such as compact disc read-only memory (CD-ROM) and digital versatile disc (DVD), magneto-optical media, such as floptical disk, and hardware devices specially configured to store and execute program instructions, such as ROM, RAM, and flash memory. Examples of the program instructions may include not only machine language code generated by a compiler but also high-level language code that is executable using an interpreter by a computer. The hardware devices described above may be configured to operate as one or more software modules so as to perform the operations of the embodiment, and vice versa.

According to one or more embodiments, a blur kernel may be estimated by considering a speed of logistics within a conveyor belt, a position of a BCR camera, and an exposure time, and a blurred barcode image may be deblurred based on the blur kernel.

In addition, since blurring of barcodes caused by movement is removed without reducing the exposure time, barcodes may be stably recognized even in a logistics center environment where luminance is low and fast-moving barcodes have to be recognized, and it is possible to be utilized in combination with surveillance cameras such as CCTV cameras. The scope of the disclosure is not limited by such an effect.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of recognizing a barcode by using a barcode reader (BCR) camera installed in a conveyor environment, the method comprising:
obtaining, by using a BCR camera, a barcode image of a barcode on an object on a conveyor;
obtaining a field of view of the BCR camera based on a conveyor environmental condition and a BCR camera setting condition;
obtaining a moving distance of the object on the conveyor by using the field of view of the BCR camera, the conveyor environmental condition, and the BCR camera setting condition;
generating a blur kernel of the barcode based on a moving direction of the object and the moving distance of the object; and
deblurring the barcode image by using a pre-trained deblurring algorithm based on the blur kernel.

2. The method of claim 1, wherein the obtaining the field of view of the BCR camera comprises:
obtaining a horizontal viewing angle and a vertical viewing angle based on an installation height of the BCR camera with respect to the conveyor, a size of an image sensor the BCR camera, and a focal length of the BCR camera; and
obtaining a horizontal field of view area and a vertical field of view area based on the horizontal viewing angle and the vertical viewing angle, respectively.

3. The method of claim 2, wherein the obtaining the moving distance comprises:
obtaining an actual moving distance of the object according to a single frame based on a speed of the conveyor and a shutter speed of the BCR camera; and
converting the actual moving distance into a moving distance according to a single pixel.

4. The method of claim 3, wherein the generating the blur kernel comprises:
obtaining a motion vector based on the moving distance according to the single pixel and the moving direction of the object; and
generating the blur kernel based on the motion vector.

5. The method of claim 1, wherein the deblurring comprises deblurring the barcode image based on the blur kernel and the barcode image by using a Wiener filter algorithm.

6. A barcode reader (BCR) camera installed in a conveyor environment, the BCR camera comprising:
an image sensor configured to obtain a barcode image of a barcode on an object moving in a moving direction at a constant speed on a conveyor at a fixed distance from the BCR camera; and
a processor configured to obtain a field of view of the BCR camera based on a conveyor environmental condition and a BCR camera setting condition, obtain a moving distance of the object on the conveyor by using the field of view of the BCR camera, the conveyor environmental condition, and the BCR camera setting condition, generate a blur kernel based on the moving direction of the object and the moving distance of the object, and deblur the barcode image by using a pre-trained deblurring algorithm based on the blur kernel.

7. The BCR camera of claim 6, wherein the processor is further configured to obtain a horizontal viewing angle and a vertical viewing angle based on an installation height of the BCR camera with respect to the conveyor, a size of the image sensor of the BCR camera, and a focal length of the BCR camera, and obtain a horizontal field of view area and a vertical field of view area based on the horizontal viewing angle and the vertical viewing angle, respectively.

8. The BCR camera of claim 7, wherein the processor is further configured to obtain an actual moving distance of the object according to a single frame based on a speed of the conveyor and a shutter speed of the BCR camera, and convert the actual moving distance into a moving distance according to a single pixel.

9. The BCR camera of claim 8, wherein the processor is further configured to obtain a motion vector based on the moving distance according to the single pixel and the moving direction of the object, and generate a blur kernel based on the motion vector.

10. The BCR camera of claim 6, wherein the processor is further configured to deblur the barcode image based on the blur kernel and the barcode image by using a Wiener filter algorithm.

11. The BCR camera of claim 6, wherein the moving direction is the only direction in which the object is moving on the conveyor.

12. A method of recognizing a barcode by using a barcode reader (BCR) camera installed in a conveyor environment, the method comprising:
obtaining, by using the BCR camera, a barcode image of a barcode on an object moving in a moving direction on a conveyor at a fixed distance from the BCR camera;
receiving a conveyor environmental condition and a BCR camera setting condition from a user;
obtaining a field of view of the BCR camera based on the conveyor environmental condition and the BCR camera setting condition, and obtaining a moving distance of the object on the conveyor by using the field of view of the BCR camera, the conveyor environmental condition, and the BCR camera setting condition;
generating a blur kernel based on the moving direction and the moving distance of the object; and
deblurring the barcode image by using a pre-trained deblurring algorithm based on the blur kernel.

13. The method of claim 12, wherein the generating the blur kernel comprises recalculating a moving speed of the object on the conveyor at preset time intervals or based on a user input, recalculating the moving distance, and regenerating the blur kernel based on the recalculated moving distance.

14. The method of claim 12, wherein the moving direction is the only direction in which the object is moving on the conveyor.
